(19) United States
(12) Patent Application Publication
(10) Pub. No.: US 2013/0319552 A1
(43) Pub. Date: Dec. 5, 2013

(54) DECONSTRUCTABLE TANKS FOR USE IN HIGH VOLUME FLUID TRANSFER OPERATIONS AND METHODS AND SYSTEMS USING SAID TANKS

(71) Applicants: Timothy Craig Svarczkopf, Moon Township, PA (US); Dean Matthew Grose, Washington, PA (US); Tad William Schirmer, McKees Rocks, PA (US); Sean Michael Beecroft, Moon Township, PA (US); Robert Glenn Hirtz, Uniontown, PA (US); Albert Eugene Butterfield, IV, Novato, CA (US)

(72) Inventors: Timothy Craig Svarczkopf, Moon Township, PA (US); Dean Matthew Grose, Washington, PA (US); Tad William Schirmer, McKees Rocks, PA (US); Sean Michael Beecroft, Moon Township, PA (US); Robert Glenn Hirtz, Uniontown, PA (US); Albert Eugene Butterfield, IV, Novato, CA (US)

(73) Assignee: Chevron USA Inc., San Ramon, CA (US)

(21) Appl. No.: 13/483,986

(22) Filed: May 30, 2012

(51) Int. Cl. B65D 13/00; F17D 1/08

(52) U.S. Cl. CPC B65D 13/00; F17D 1/08
USPC 137/565.01; 220/4.16; 29/428

(57) ABSTRACT

Disclosed is a deconstructable water storage tank assembled using modular components including wall panels, a base ring and a membrane for use in large volume fluid transfer operations such as hydraulic fracturing. Also disclosed are methods for assembling the tank for use at a first hydraulic fracturing site, and disassembling and transporting the tank components for redeployment at a second hydraulic fracturing site. A fluid management system is also disclosed utilizing the deconstructable storage tank.

### FIELD

The present disclosure relates to deconstructable storage tanks for use in high volume fluid transfer operations such as hydraulic fracturing to produce natural gas from shale. The present disclosure further relates to methods for deploying and redeploying such tanks, and water management systems utilizing such tanks.

### BACKGROUND

In high volume fluid transfer operations, such as hydraulic fracturing to produce natural gas from shale, large amounts of water are required to be stored and managed. For instance, several millions of gallons of water can be required for hydraulic fracturing at a single well. Water is stored on site near the well, and is blended with a proppant material such as sand to form a slurry which is injected into the well and into the shale formation, thus opening the shale formation to allow natural gas or oil to flow. Water is returned from the shale through the well to the surface in the form of flowback water. This water can then be treated to remove contaminants and reused at additional well sites.

A limited number of options are currently available to manage water storage at a well site. According to one currently available option, many 500 barrel (bbl) storage tanks are rented for the duration of hydraulic fracturing and flowback operations at a particular well. The use of such tanks results in very large well pad area requirements, which is undesirable from land use, environmental and aesthetic perspectives. Such tanks are furthermore difficult to clean and expensive to rent.

A second currently available option for managing water storage in hydraulic fracturing operations is the use of large deconstructable water storage tanks, such as 25,000 bbl deconstructable water storage tanks. One such tank 10 having an interior 18 for storing hydraulic fracturing fluid 12 is illustrated in FIG. 1. Such tanks are typically 15 foot (4.6 m) high structures made up of steel panels 16. The tanks are typically lined with a polyvinyl chloride (PVC) or polypropylene (PP) bag or liner. These are expensive to rent and also result in very large well pad requirements. The tank may rest on a cement pad 14 in the ground 1. The liners can present difficulties for disposal, and the liners can also be inadvertently sucked into pumps that remove water from the tank during operation. Such tanks do not meet American Water Works Association (AWWA) seismic code and must be built at lower heights to meet 100 mph wind code. Furthermore, it can be difficult to place this type of tank with secondary water containment.

A third currently available option used to manage water storage in hydraulic fracturing operations is illustrated in FIG. 2. Open ponds or pits 20 such as 25,000 bbl pits are lined with PVC or PP liners 22. Such pits have a maximum depth of 15 feet (4.6 m) indicated at 92, and have slope requirements indicated at 80 of no more than 3:1 (horizontal:vertical). Such pits therefore result in large well pad requirements. As indicated by 90, 6 typical tank widths 10 can fit within one such pond 20. Such pits typically require fencing or other barriers to prevent unauthorized entry. Double liners can be used to reduce the likelihood of leakage, but this adds to the cost. Furthermore, open pits for flowback water may be aesthetically unappealing.

The need remains for improved water storage management in high volume fluid transfer operations such as hydraulic fracturing. It would be desirable to have a system which would not require a large well pad area and which could be easily assembled, disassembled and transported to multiple well sites. It would further be desirable for the system to meet American Water Works Association (AWWA) specifications, seismic code, wind load code and increased water storage.

### SUMMARY

In one aspect, a method is provided for deploying a deconstructable tank for storing fluid used in hydraulic fracturing operations or other high volume fluid transfer operations. A plurality of base ring pieces is attached to one another to form a base ring having a circular cross section. The base ring is set in a predetermined location. A membrane is placed over the base ring. A series of curved panels is sequentially positioned in cooperating arrangement to form a first horizontal band wherein the curved panels are attached to one another and to the base ring. Additional series of curved panels are sequentially positioned in cooperating arrangement to form additional horizontal bands, thus forming a cylindrical tank wall, wherein the curved panels are attached to one another and to the previously formed horizontal band.

In another aspect, a deconstructable tank is provided, including a base ring having a circular cross section; a cylindrical tank wall comprising a plurality of vertically aligned horizontal bands; and a membrane between the lowermost horizontal band and the base ring. Each of the horizontal bands includes a plurality of curved panels attached to one another with lap joints. Adjacent horizontal bands are attached to one another. The lowermost horizontal band is attached to the base ring.

In yet another aspect, a fluid management system for managing fluid in hydraulic fracturing operations is provided. The system includes the deconstructable tank; an inlet conduit in fluid communication with the tank adapted to feed fluid to the tank; a first pump for supplying fluid to the inlet conduit to supply fluid to the tank; and an outlet adapted to feed fluid from the bottom of the tank to a blender.

### DESCRIPTION OF THE DRAWINGS

These and other objects, features and advantages of the present invention will become better understood with reference to the following description, appended claims and accompanying drawings where:

FIG. 1 is a cutaway front view of a fluid storage tank according to the prior art.

FIG. 2 is a cross-sectional side view of a fluid storage pit according to the prior art.

FIG. 3 is a cutaway front view of a fluid storage tank according to one exemplary embodiment.

FIG. 4 is an exploded view of a fluid storage tank according to one exemplary embodiment.

FIG. 5A is a cross-sectional top view of a fluid storage tank wall according to one exemplary embodiment.

FIGS. 5B-5G are cross-sectional views of individual panels used in the fluid storage tank wall of FIG. 5A.

FIG. 6A is a top view of a fluid storage tank base ring according to one exemplary embodiment.

FIG. 6B is a side view of a base ring segment used in the base ring of FIG. 6A.

FIG. 6C is a top view of a base ring segment used in the base ring of FIG. 6A.

FIG. 7 is a detailed view of a seam between two overlapping panels in the fluid storage tank wall of FIG. 5A.

FIG. 8 is an illustration of a crane lifting a fluid storage tank wall panel according to one exemplary embodiment.

FIG. 9 is a schematic diagram illustrating a fluid management system according to one exemplary embodiment.

FIGS. 10-12 are an exploded view, a cross-sectional view and a front view, respectively, of a bolt capture compression plate system according to one exemplary embodiment.

### DETAILED DESCRIPTION

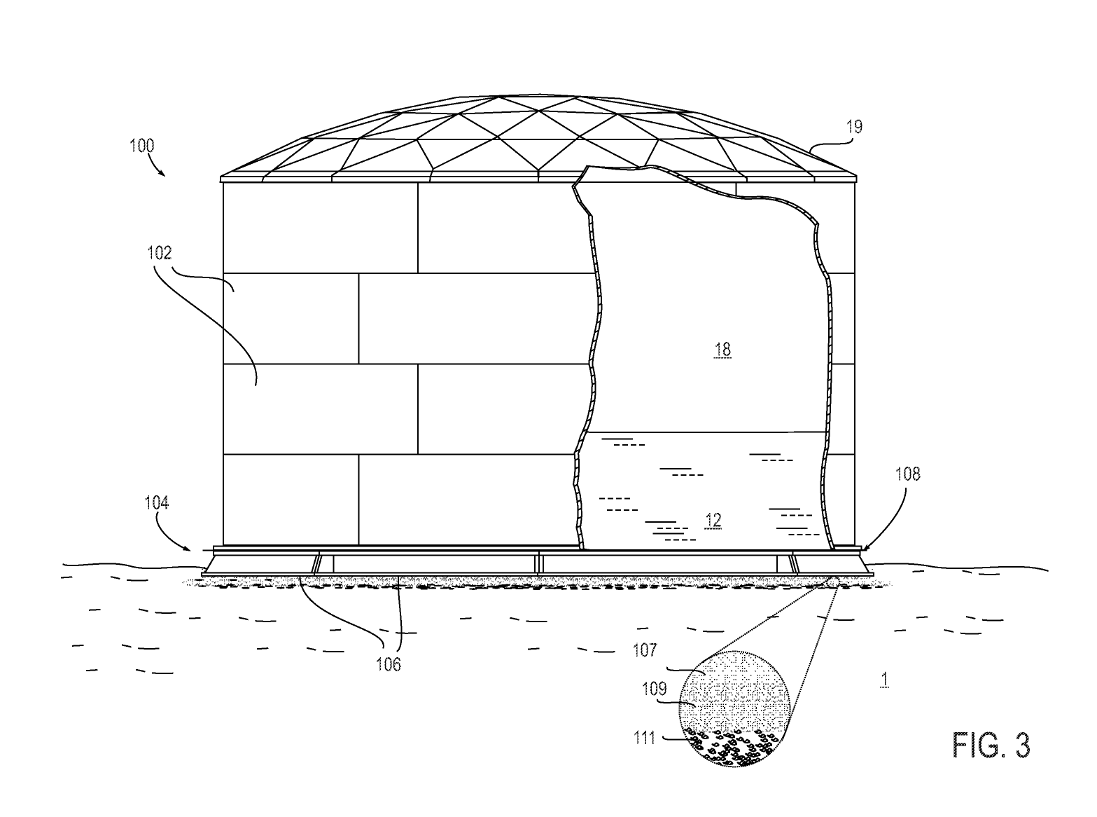

A deconstructable tank 100 for storing fluid 12 used in hydraulic fracturing operations or other high-volume fluid transfer operations is illustrated in FIG. 3. As can be seen, the deconstructable tank 100 includes a base ring 104 also referred to herein as a base plate 104 having a circular cross section. The base ring 104 provides vertical stability for the tank wall and serves as half of a capture flange for capturing a floor membrane. The tank has a cylindrical wall made up of multiple horizontal bands with chimes or flanges attached to one another. The lowermost horizontal band is attached to the base ring. Each horizontal band is made up of a plurality of curved panels 102 attached to one another at lap joints.

In one embodiment, a membrane 108 located between the lowermost horizontal band and the base ring 104 forms the floor of the tank. In this embodiment, the deconstructable tank 100 advantageously does not require a concrete base foundation or floor or other rigid steel floor plating. Suitable membrane materials include sheet materials such as polyvinyl chloride (PVC), polypropylene (PP), linear low-density polyethylene (LLDPE) and high-density polyethylene (HDPE) sheet. It may be advantageous to use to layers of membrane material. The membrane 108 can be reinforced for increased durability. Reinforced PVC having thickness of 40 mils (4.6 mm) is an example of a suitable membrane material. In other embodiments, the tank floor can be a concrete base foundation or rigid steel floor plating.

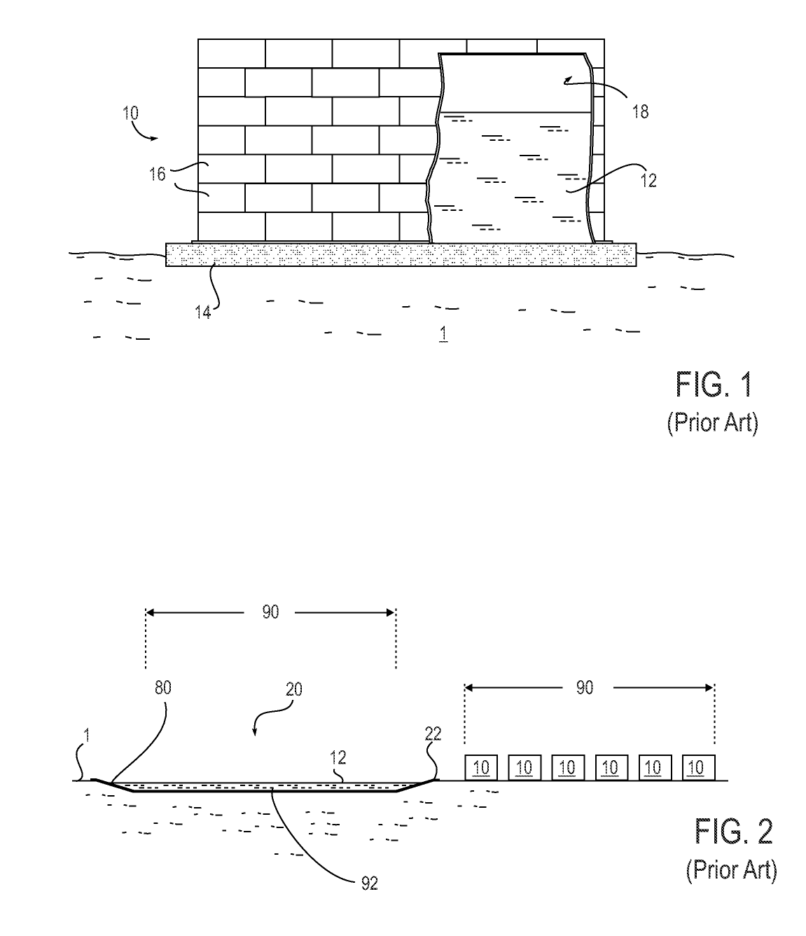

The cylindrical tank wall of the deconstructable tank has a height of at least 15 feet (4.57 m), even at least 30 feet (9.14 m) and even at least 40 feet (12.2 m). Each of the curved panels 102 has a height of at least 9 feet (2.7 m). The curved panels 102, also referred to as wall panels 102, are formed from carbon steel. The degree of curvature or arc of each panel can vary depending on the number of panels used to form the round cross-sectional wall of the tank. The curved panels 102 are advantageously significantly larger than wall panels used in prior art tanks. For example, a prior art 1,000,000 gallon storage tank 10 such as that illustrated in FIG. 1 is made up of 389 wall panels 16 wherein each panel is 5 feet high by 9 feet wide (1.5 m by 2.7 m). By contrast, a 1,000,000 gallon storage tank 100 according to the present disclosure is made up of 24 panels 102 that are 9 feet high by 37 feet wide (2.7 m by 11.3 m), resulting in a tank that is 36 feet (11.0 m) in height and 71 feet (21.6 m) in diameter. This reduction in the number of wall panels 102 results in a significant reduction in time to assemble the tank 100, from about 25 days to about four days. Additionally, the number of through wall bolts connecting the wall panels is greatly reduced. In this example, the number of through wall bolts is reduced by 90%, greatly reducing the risk of leaks through the tank wall. A minimum number of bolts necessary to meet appropriate industry codes, such as American Water Works Association (AWWA) D103-09 seismic code (Ss=10.6%, SI=5.3%, Seismic Use Group=3) and 100 mph wind load can be calculated based on the amount of stress on the bolts and the amount of mass in the tank.

Advantageously, the deconstructable tank 100 has a volumetric capacity of at least 200,000 gallons (760 cubic meters), even at least 1 million gallons (3800 cubic meters).

The deconstructable tank 100 can also include a roof 19, such as a domed roof or any other roof which can be attached to the uppermost horizontal band. Alternatively, a floating roof can be used. Advantageously, the domed roof can include a vent.

The deconstructable tank can optionally be equipped with an aerator connected with a compressed air supply within the deconstructable tank to avoid density striations within the fluid in the tank, to avoid microbial activity and to avoid freezing in the winter.

The deconstructable tank can also optionally be equipped with a float gauge for monitoring the fluid level within the tank, detectors for lower explosion limit (LEL) monitoring, hydrogen sulfide monitoring, and the like. The tank can be equipped with additional accessories as would be apparent to one skilled in the art.

The deconstructable tank can also optionally be equipped with one or more manways in the tank wall through which a person can enter the tank for the purposes of cleaning.

The deconstructable tank 100 can easily be deployed in one location, e.g., a hydraulic fracturing site, and later disassembled, transported and redeployed in a second location. The base ring pieces 106, wall panels 102, membranes 108 and other components are sized to be transportable by at least one transportation vehicle via roadway without the need for special permitting for wide loads and the like.

To assemble the tank 100, at a predetermined location, a support surface is prepared onto which the base ring 104 will be set. The support surface is prepared by excavating the ground 1 onto which the base ring will be set. The depth of excavation will depend on the soil loading pressure as determined by a soil survey. This can vary between a few inches and a few feet. Engineered fill is placed into the excavated area. In some embodiments, the engineered fill is placed in sequential layers, with a bottom layer of coarse fill material 111, followed by finer gravel 109 and finally sand 107.

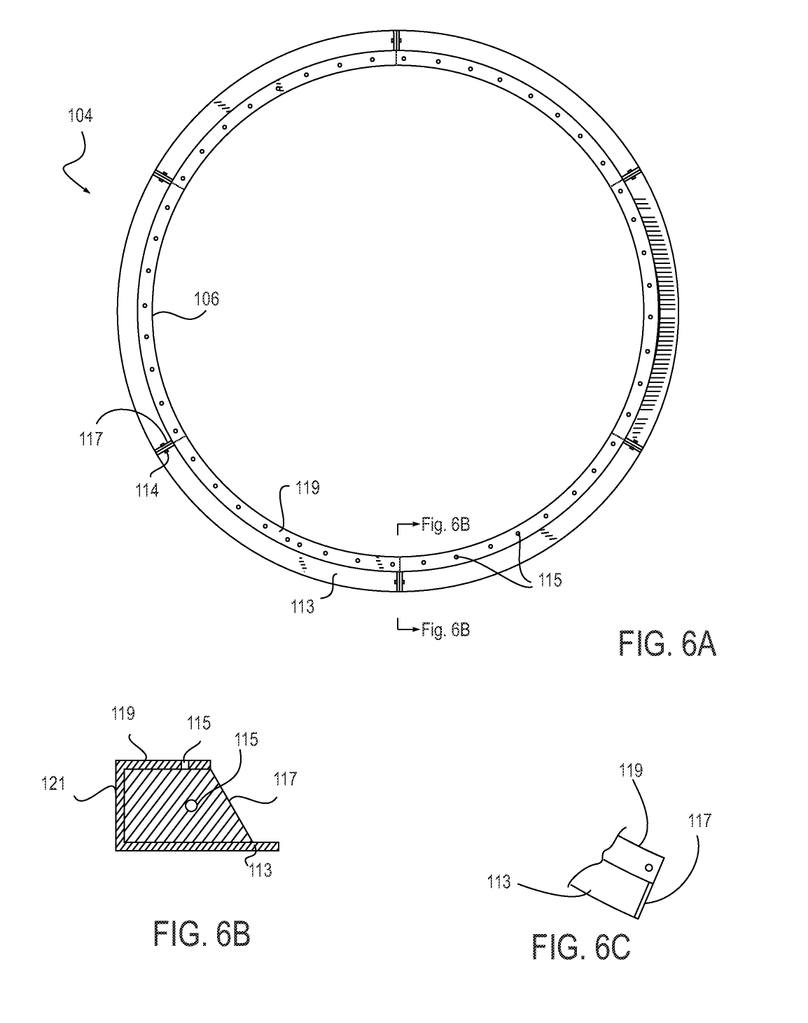

The appropriate number of base ring pieces 106, illustrated in FIGS. 3, 4 and 6A, are attached to one another to form the base ring 104 which is set in place on the support surface. As can be seen in the side view of FIG. 6B, in one embodiment, the base ring pieces are gusseted, i.e., having a top portion 119 and a bottom portion 113. The top portion 119 of the base ring, also referred to as the top of the base plate, forms the bottom half of a flange having holes 115 through which bolts 114 are inserted to attach the lowermost horizontal band to the base ring 104. The lower edge of the wall panels making up the first horizontal band form the top half of the flange, and are attached to the top portion 119 of the base ring 104. Each base ring piece 106 has two support walls 117 at either end having a bolt hole 115 there through for connection of adjacent base ring pieces 106. FIG. 6C illustrates one end of a base ring piece 106, including support wall 117, top portion 119 and bottom portion 113.

Once the base ring 104 is assembled as shown in FIG. 6A, at least one layer of membrane 108, preferably two layers, is placed over the base ring. The membrane layer(s) offer the advantages of being durable, easily transportable and easily replaced as needed.

Gaskets (not shown) are optionally included above, below and/or between the membrane layers 108. The gaskets are compressed by the bolts attaching the lowermost horizontal band to the base ring to ensure no leakage through the gasket. Gasket materials suitable for use include ethylene diene propylene monomer (EDPM), neoprene rubber and the like.

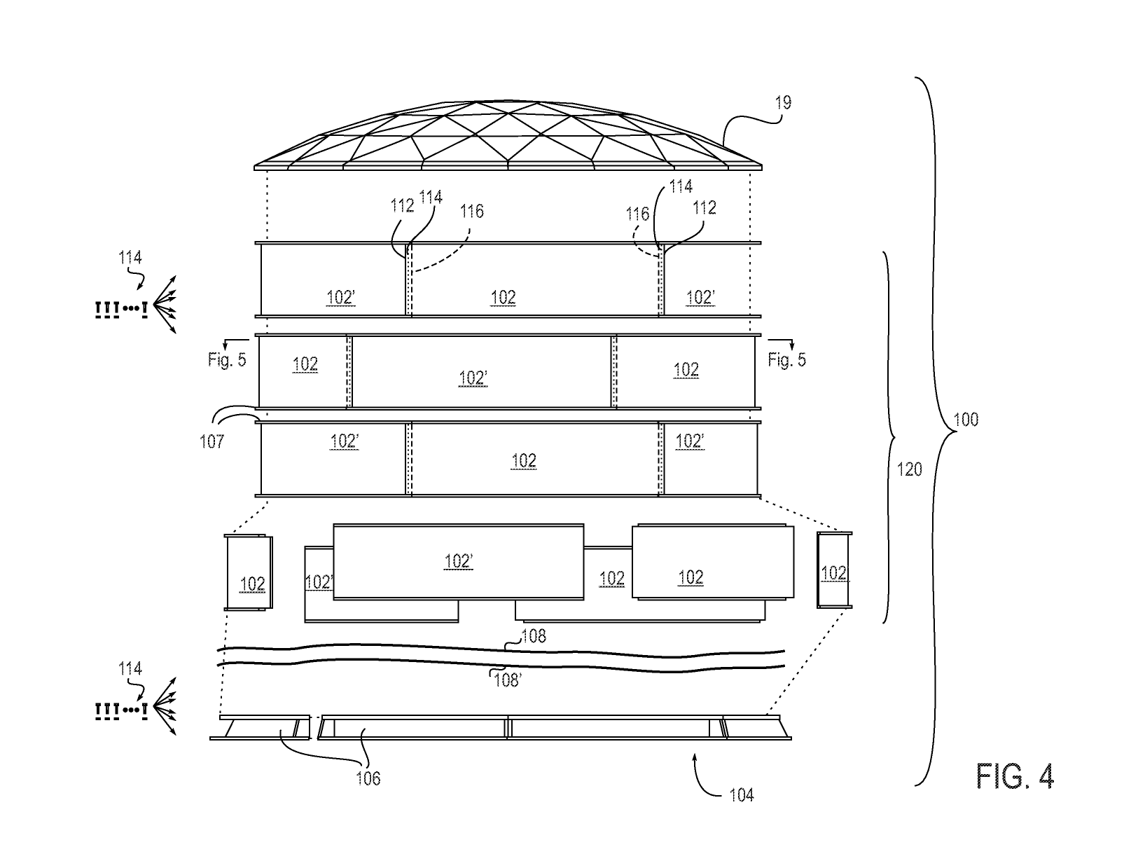

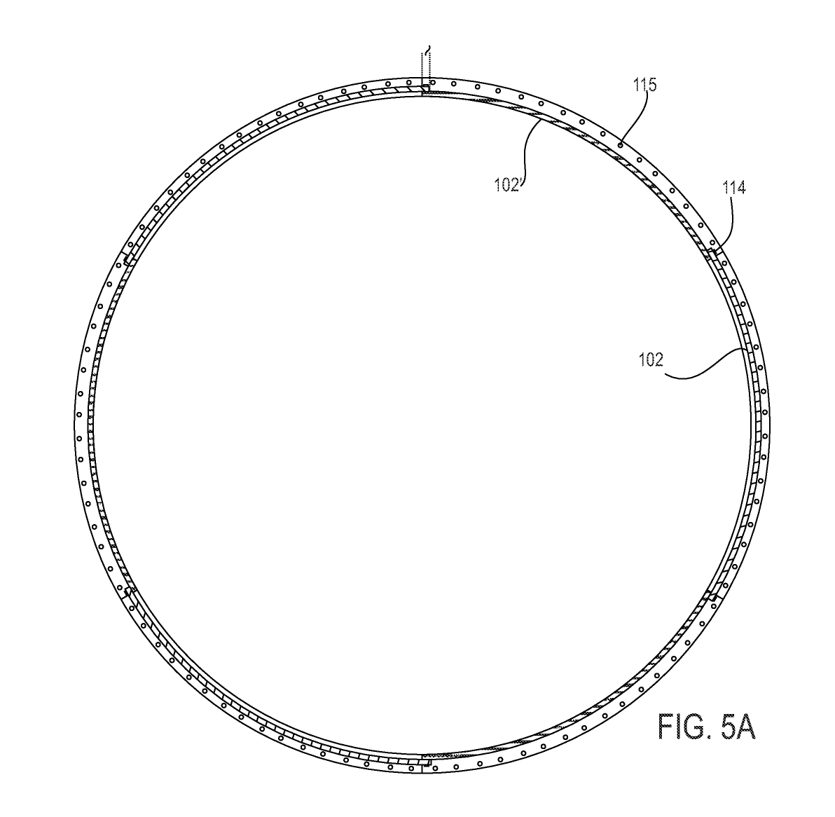

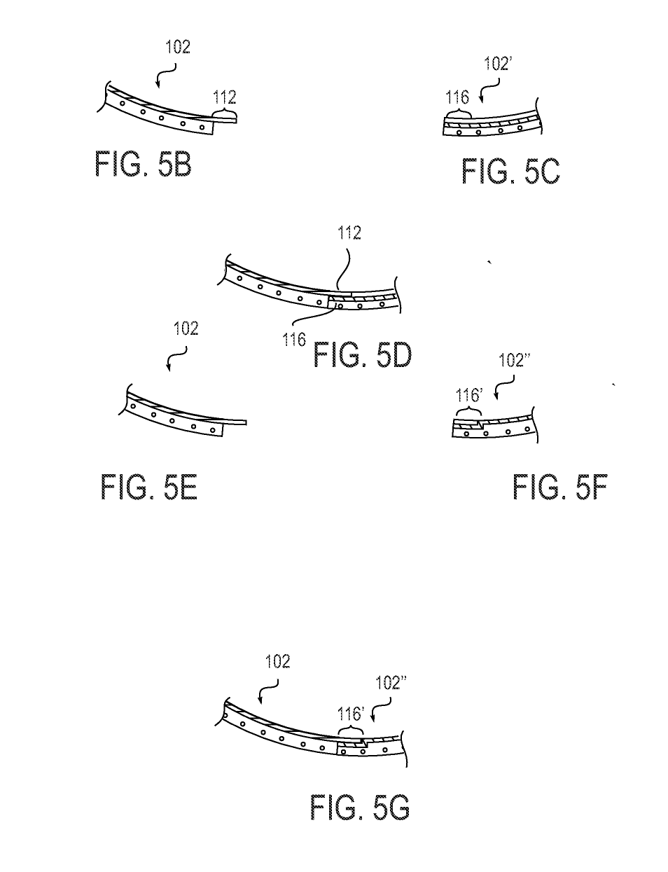

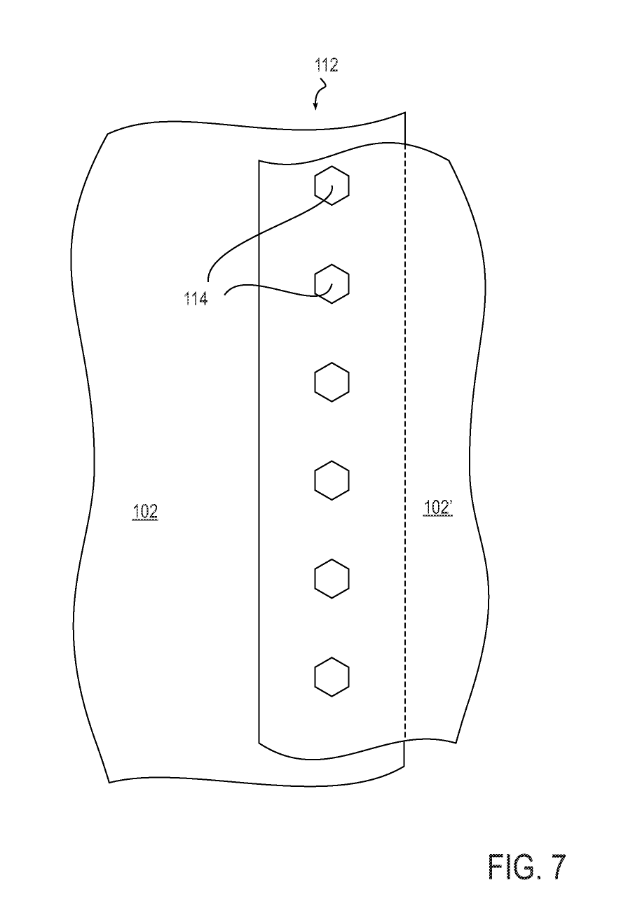

Each of a first plurality or set of curved wall panels 102 is sequentially positioned in cooperating arrangement, and attached to one another and to the base ring 104 to form a first horizontal band. Referring to FIG. 4, curved wall panels 102 which are adjacent to each other horizontally can be attached to one another using through wall bolts 114 through lap joints made up of an overlap 112 and an underlap 116 at each of the vertical seams between adjacent panels 102. Because of the alternating underlap and overlap of the wall panels, adjacent wall panels alternate between more interior panels 102′ and more exterior panels 102. This can also be seen in FIG. 5A illustrating a cross-sectional view of the tank wall. The vertical wall portion of panel 102′ is flush with the interior of the wall, while the vertical wall portion of panel 102 is more towards the exterior of the wall. Bolt holes are shown by 115. FIG. 7 illustrates the overlap joint 112 including bolts 114 attaching adjacent panels 102 and 102′.

FIGS. 5B-D further illustrate this embodiment. FIG. 5B illustrates an end of one of the “exterior panels” 102 having an overlap region 112. FIG. 5C illustrates an end of one of the “interior panels” 102′ having an underlap region 116. FIG. 5D illustrates the overlap joint between 102 and 102′.

FIGS. 5E-G illustrate an alternative embodiment. FIG. 5E illustrates an end of wall panel 102 having an overlap region 112. FIG. 5F illustrates an end of a specially designed panel 102″ having a recessed region 116′ within the vertical portion of the wall. FIG. 5G illustrates the overlap joint between 102 and 102″. As can be seen from FIG. 5G, the interior of the tank wall is smooth in this embodiment.

The number and spacing of the bolts 114 is according to seismic code. The bottom edge of each curved wall panel 102 has a chime style edge 107, i.e., half of a flange, so that the joint between the lowermost horizontal band and the base ring is a butt joint. Once the first horizontal band is in place, each of a second plurality of curved wall panels 102 is likewise sequentially positioned to form a second horizontal band in which the curved panels are attached to one another and to the first horizontal band. Additional sets of curved panels 102 are likewise attached to form at least one additional horizontal band, to build up the tank wall 120 vertically. Adjacent horizontal bands can be attached to one another using bolts 114 through butt joints between flanged edges 107.

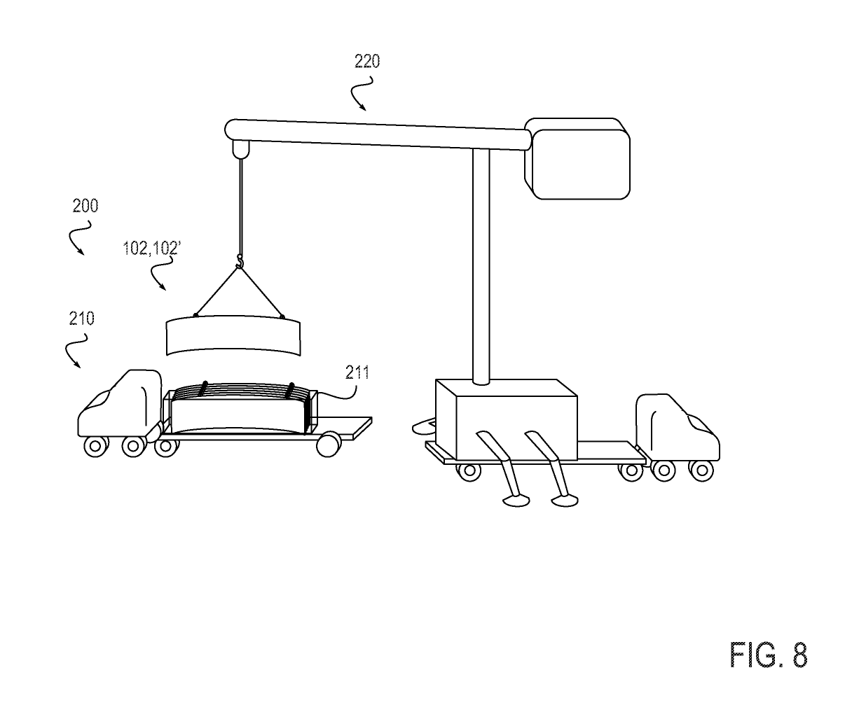

As shown in the operation 200 illustrated in FIG. 8, during the assembly of the tank 100, each panel 102, 102′ is lifted by a crane 220. In the illustration of FIG. 8, the crane is lifting each panel 102, 102′ in a crate 211 directly from a transportation vehicle 210. Alternatively, sets of panels can be packed into a single crate 211. The crane 220 can be located near the desired predetermined tank location. Each panel 102, 102′ can then be positioned by the crane 220 in its intended position relative to the base ring 104 and any other wall panels 102, 102′ already installed. The crane 220 can be used to hold the panel 102, 102′ in position while bolts 114 are installed attaching the panel to adjacent structures. Lifting eyes can be provided on each wall panel for enabling lifting by the crane. Optionally (not shown), a second crane can lift a second wall panel and hold the second wall panel in place adjacent the previous wall panel while the first crane continues to hold the first panel in position to facilitate attachment of adjacent panels.

All joints between adjacent components, e.g., along horizontal seams, vertical seams and at tees where horizontal and vertical seams intersect, can include gasket material (not shown). Again, suitable gasket materials include EDPM, neoprene rubber and the like. All seams and joints can also be caulked and mastic coated with sealant as would be apparent to one skilled in the art.

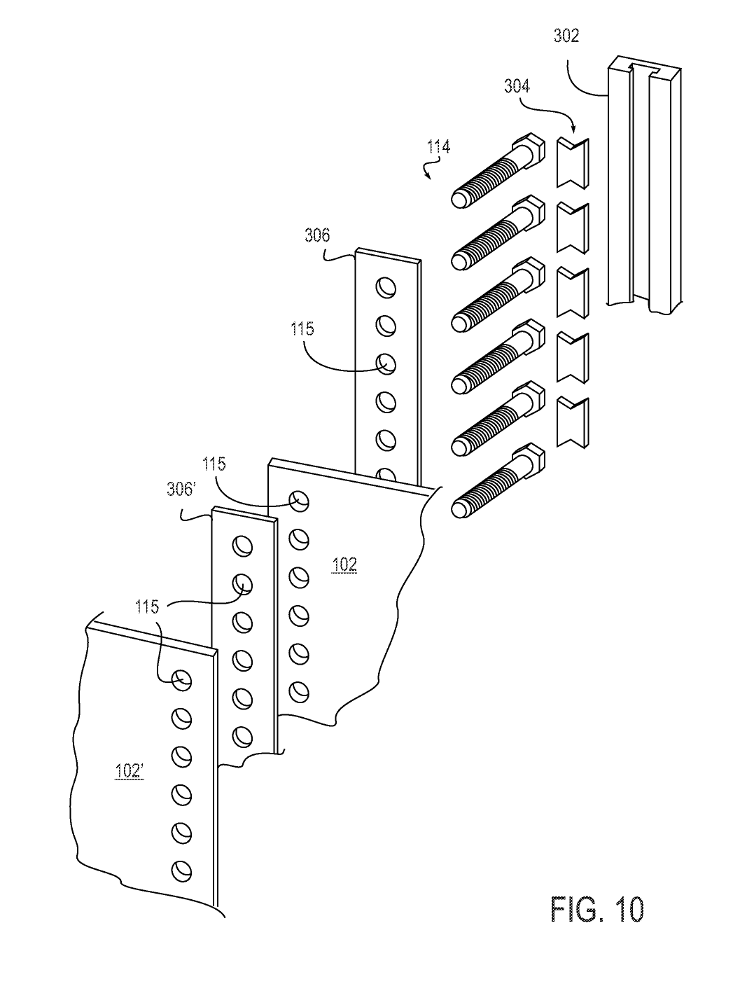

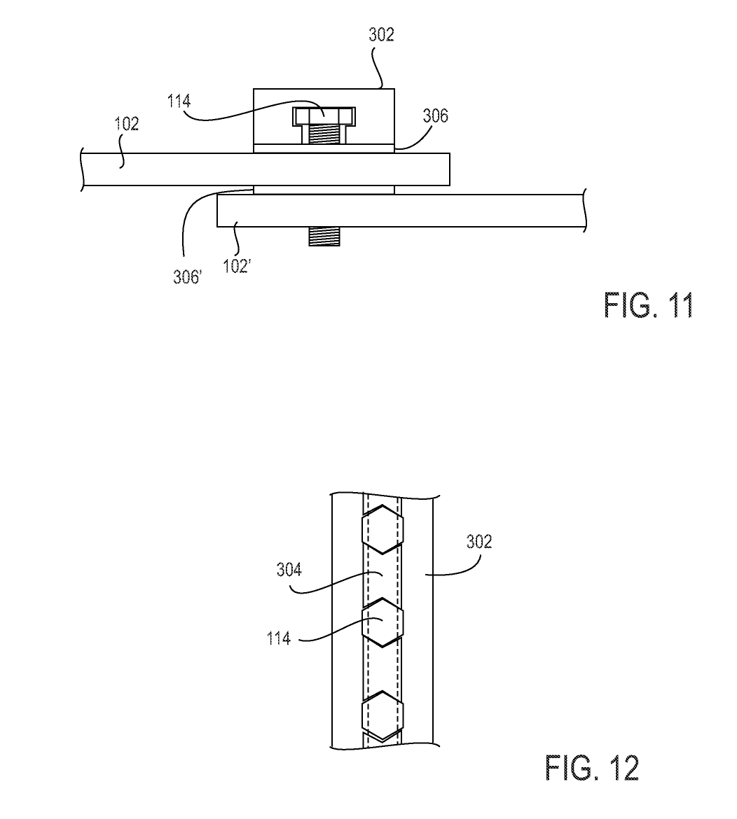

In one embodiment, a system of bolt capture compression plates is provided in the overlap joints between adjacent curved panels of each horizontal band. As illustrated in FIG. 10, a bolt capture compression plate 302 is configured to receive bolt spacers 304 and the heads of bolts 114. Gasket strips 306 and 306′ can be provided with bolt holes 115 to match the spacing of the bolts 114 in the bolt capture compression plate 302 with the bolt spacers 304 there between. As shown, a gasket strip 306 is positioned between the bolt capture compression plate 302 and wall panel 102, and another gasket strip 306′ is positioned between adjacent wall panels 102 and 102′. FIG. 11 is a side view of the overlap joint. FIG. 12 is a front view of the bolt capture compression plate 302, including bolts 114 with the bolt spacers 304 there between. This embodiment offers the advantage of solid gasketing along the vertical seam of the overlap joints, rather than discontinuous gasket material which can introduce the risk of leaks. The gasket strips can be any suitable gasket material, including EDPM, neoprene rubber and the like.

The deconstructable tank 100 can be disassembled easily by reversing the order of the assembly method steps. Each of the curved panels 102, 102′ of the uppermost horizontal band can be sequentially unbolted and detached from each other and from the adjacent horizontal band. Next, each of the panels 102, 102′ of the remaining horizontal bands can be sequentially unbolted and detached from one another and from the adjacent horizontal band or base ring 104 in the case of the lowermost horizontal band. The membrane(s) 108 can then be removed from the base ring 104. Finally, the base ring pieces 106 can be unbolted and detached from one another. All of the tank components can then be packed in at least one vehicle 210 and transported to another location, such as a second hydraulic fracturing site, for redeployment. For transport, it may be advantageous to pack into an individual crate 211 or cradle a set of wall panels 102, 102′ which make up a horizontal band.

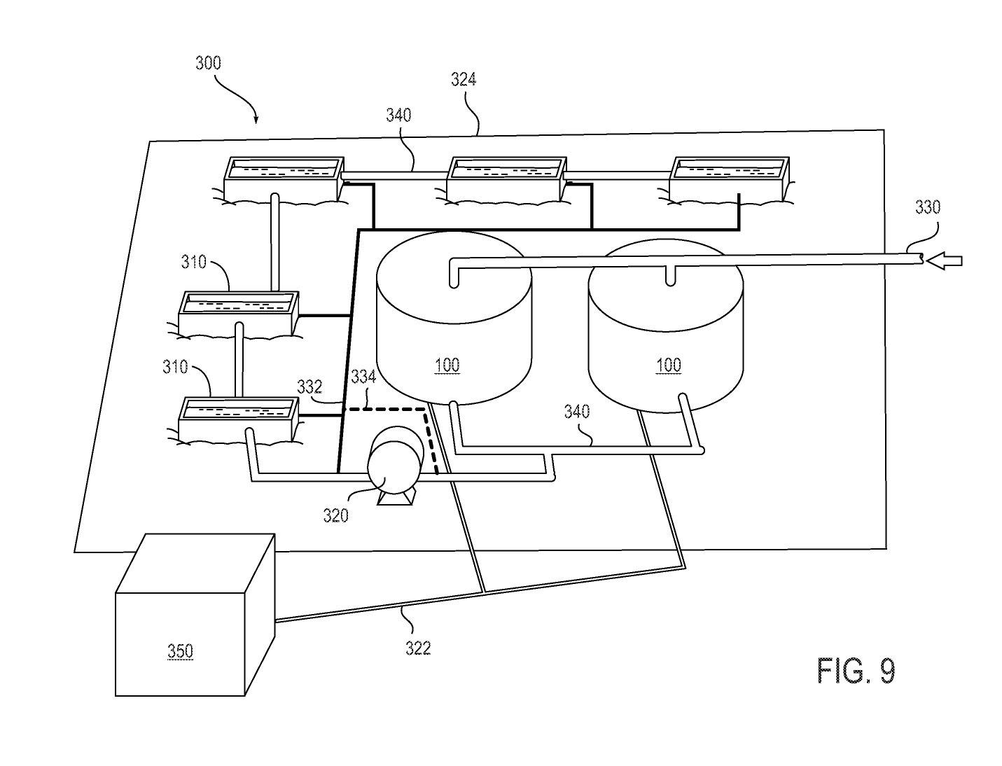

In one embodiment, referring to FIG. 9, a fluid management system 300 is provided for managing fluid in hydraulic fracturing operations or other high-volume fluid transfer operations. Fluid can be fed to the deconstructable tanks 100 by an inlet conduit 330 in fluid communication with the tanks 100. The inlet conduit 330 can feed fluid from the top of the tanks into the tanks via an L tube, J tube, and/or a splash plate (not shown) to eliminate erosion of the tank floor.

One or more pumps 320 can supply fluid to conduit 340 to fill the tanks 100. Alternatively, pump 320 can supply fluid to inlet conduit 332 via conduit 334 to fill the tanks 100. One or more pumps 320 can be used to pump water from truck station tanks 310, described below, into the vertical de-constructable tanks 100.

In one embodiment, the fluid management system 300 includes at least one open top container also referred to as a truck station tank 310 in fluid communication with the pump 320. Each open top container 310 can receive fluid from a fluid storage compartment on a truck or transportation vehicle (not shown), such as via a hose (not shown) attached to the fluid storage compartment on the vehicle. The open top containers 310 can be at least partially buried, or otherwise positioned so that transfer of fluid from the vehicle is assisted by gravity. In one embodiment, each open top container 310 is approximately 8 feet wide (2.4 m) by 33 feet long (10.0 m) by 6 feet high (1.8 m) and can hold 235 bbl of fluid while allowing freeboard space. Two transportation vehicles can unload water at each such open top container 310 simultaneously.

The fluid management system 300 can include a recirculating line 332 between at least one of the open top containers 310 and the conduit 340 for circulating fluid to prevent freezing in the winter. Water is recirculated back into the truck station tanks to prevent freezing in the winter.

In an alternative embodiment, not shown, the fluid management system 300 can include at least one inlet (not shown) in fluid communication with the pump 320 wherein each inlet is adapted to be connected with the fluid storage compartment on the vehicle or to a hose attached to the fluid storage compartment on the vehicle.

The deconstructable tanks 100 can be provided with lines 322 adapted to feed fluid from the bottom of the deconstructable tanks 100 to a blender 350 where the fluid is mixed with proppant material to form a slurry which is pumped into the well and into the shale formation in the earth. In one embodiment, between tens and hundreds of barrels per minute are fed to the blender. Preferably, lines 322 feed fluid from the bottom of the tanks 100 to the blender 350 by gravity, to minimize pumping.

In one embodiment, a second pump (not shown) can be provided to supply fluid from the bottom of the deconstructable tank to a fluid treatment facility and from the fluid treatment facility to the deconstructable tank. The fluid treatment facility can be a facility using known technology to clarify used hydraulic fracturing fluid (also referred to as flowback water). The clarified water can then be returned to the deconstructable tank for storage prior to being pumped out from the top of the tank and reused at another location.

The fluid management system 300 includes a means for containment such as a surrounding berm 324 capable of holding 110% of the volume of the largest deconstructable tank 100.

Water storage systems using the deconstructable tank 100 offer several advantages when compared with prior art systems. When compared with storage pits, the required area for the system is decreased by over 40%, safety and environmental risks are reduced, and cost is reduced significantly. When compared with 500 bbl tanks, the required area is decreased by approximately 60% and cost is reduced significantly. When compared with conventional water tanks of a similar size, the assembly time of 1,000,000 gallon tanks is reduced from approximately 4 weeks to approximately one week. The large, modular wall panels allow for faster construction and deconstruction time while not requiring special wide load permits to transport. The larger wall panels also reduce the amount of seams between panels and the number of bolts needed, thereby reducing the risk of leaks. The base ring and membrane allow the tank to be built without using concrete or other rigid flooring. The base ring allows the wall panels to be aligned and correctly oriented to ensure tank integrity and facilitate assembly.

Unless otherwise specified, the recitation of a genus of elements, materials or other components, from which an individual component or mixture of components can be selected, is intended to include all possible sub-generic combinations of the listed components and mixtures thereof. Also, “comprise,” “include” and its variants, are intended to be non-limiting, such that recitation of items in a list is not to the exclusion of other like items that may also be useful in the materials, compositions, methods and systems of this invention.

From the above description, those skilled in the art will perceive improvements, changes and modifications, which are intended to be covered by the appended claims.

What is claimed is:

1. A method for deploying a deconstructable tank for storing fluid used in hydraulic fracturing operations or other high volume fluid transfer operations, comprising:
a. attaching a plurality of base ring pieces to form a base ring having a circular cross section;
b. setting the base ring in a predetermined location;
c. placing a membrane over the base ring;
d. sequentially positioning a series of curved panels in a first plurality of curved panels in cooperating arrangement to form a first horizontal band wherein the curved panels are attached to one another and to the base ring;
e. sequentially positioning a series of curved panels in a second plurality of curved panels in cooperating arrangement to form a second horizontal band wherein the curved panels are attached to one another and to the first horizontal band; and
f. repeating step (d) with at least one additional plurality of curved panels to form at least one additional horizontal band to form a cylindrical tank wall.

2. The method of claim 1, wherein the cylindrical tank wall has a height of at least 4.6 m.

3. The method of claim 1, wherein the cylindrical tank wall has a height of at least 9 m.

4. The method of claim 1, wherein each curved panel is held in position by a crane while being attached.

5. The method of claim 1, wherein the base ring comprises a top portion, the method further comprising:
attaching the first plurality of curved panels to the top portion of the base ring using bolts;
attaching the curved panels of each plurality of curved panels to one another in overlapping arrangement using bolts to form each horizontal band; and
attaching adjacent horizontal bands to one another using bolts.

6. The method of claim 5, further comprising:
positioning bolt capture compression plates between adjacent curved panels of each horizontal band.

7. The method of claim 1, wherein prior to setting the base ring in the predetermined location, a support surface is prepared comprising engineered fill material at the predetermined location.

8. The method of claim 7, wherein the engineered fill material comprises at least one layer of material selected from the group consisting of coarse gravel, fine gravel and sand.

9. The method of claim 1, further comprising:
prior to step (a), transporting the base ring pieces, the membrane and the curved panels in at least one transportation vehicle via roadway to a hydraulic fracturing site.

10. The method of claim 1, further comprising disassembling the deconstructable tank comprising the following steps:
g. sequentially detaching each of the curved panels of the uppermost horizontal band from one another and from the adjacent horizontal band;
h. sequentially detaching each of the curved panels of the remaining horizontal bands from one another and from the adjacent horizontal band or base ring;
i. removing the membrane from the base ring; and
j. detaching the plurality of base ring pieces.

11. The method of claim 10, further comprising redeploying the deconstructable tank comprising:
k. packing the base ring pieces, the membrane and the curved panels; and
l. transporting the packed base ring pieces, membrane and curved panels in at least one vehicle via roadway from the hydraulic fracturing site to a second hydraulic fracturing site.

12. A deconstructable tank comprising:
a. a base ring having a circular cross section;
b. a cylindrical tank wall comprising a plurality of vertically aligned horizontal bands, wherein:
i. each of the horizontal bands comprises a plurality of curved panels attached to one another with lap joints;
ii. adjacent horizontal bands are attached to one another; and
iii. the lowermost horizontal band is attached to the base ring; and
c. a membrane between the lowermost horizontal band and the base ring.

13. The deconstructable tank of claim 12, wherein the cylindrical tank wall has a height of at least 4.6 m.

14. The deconstructable tank of claim 12, wherein each of the plurality of curved panels has a height of at least 2.7 m.

15. The deconstructable tank of claim 12, wherein the deconstructable tank deconstructable tank has a volumetric capacity of at least 200,000 gallons (760 cubic meters).

16. The deconstructable tank of claim 12, wherein the deconstructable tank deconstructable tank has a volumetric capacity of at least 1 million gallons (3800 cubic meters).

17. The deconstructable tank of claim 12, further comprising a domed roof attached to the cylindrical tank wall wherein the domed roof comprises a vent.

18. The deconstructable tank of claim 12, further comprising an aerator within the deconstructable tank.

19. The deconstructable tank of claim 12, wherein the membrane comprises a sheet material selected from the group consisting of PVC sheet, polypropylene sheet, linear low-density polyethylene sheet, high-density polyethylene sheet and combinations thereof

20. The deconstructable tank of claim 12, wherein the tank has no rigid floor.

21. A fluid management system for managing fluid in hydraulic fracturing operations, comprising:
a. the deconstructable tank of claim 12;
b. an inlet conduit in fluid communication with the tank adapted to feed fluid to the tank;
c. a first pump for supplying fluid to the inlet conduit to supply fluid to the tank; and
d. an outlet adapted to feed fluid from the bottom of the tank to a blender.

22. The fluid management system of claim 21, further comprising a second pump adapted to supply fluid from the tank to a fluid treatment facility and from the fluid treatment facility to the tank.

23. The fluid management system of claim 21, wherein the inlet conduit feeds fluid from the top of the tank into the tank via an L tube, J tube, and/or splash plate.

24. The fluid management system of claim 21, further comprising at least one inlet in fluid communication with the first pump; wherein each inlet is adapted to be connected with a hose attached to a fluid storage compartment on a transportation vehicle.

25. The fluid management system of claim 21, further comprising at least one open top container in fluid communication with the first pump; wherein each open top container is adapted to receive fluid from a hose attached to a fluid storage compartment on a transportation vehicle.

26. The fluid management system of claim 21, further comprising a recirculating line between the at least one of the top container and the inlet conduit for circulating fluid to prevent freezing.

27. The fluid management system of claim 21, wherein the outlet feeds fluid from the bottom of the tank to a blender by gravity.

28. The fluid management system of claim 22, further comprising a fluid treatment facility for clarifying used hydraulic fracturing fluid pumped from the deconstructable tank by the second pump.
